(19) United States
(12) Patent Application Publication
(10) Pub. No.: US 2023/0199751 A1
(43) Pub. Date: Jun. 22, 2023

(54) Wake-Up Signal Collision Handling for NR Multicast

(71) Applicant: QUALCOMM Incorporated, San Diego, CA (US)

(72) Inventors: Min HUANG, Beijing (CN); Chao WEI, Beijing (CN); Jing DAI, Beijing (CN)

(21) Appl. No.: 17/999,395

(22) PCT Filed: Jul. 27, 2020
(86) PCT No.: PCT/CN2020/104779

§ 371 Date: Nov. 21, 2022

(51) Int. Cl. H04W 72/1263; H04W 72/23; H04W 72/566; H04W 52/02

(52) U.S. Cl. CPC H04W 72/1263; H04W 72/23; H04W 72/566; H04W 52/0229

(57) ABSTRACT

Embodiments include systems and methods for managing multicast communications between a wireless device and a base station. Various embodiments may include determining whether a multicast search space (MSS) and a multicast wake-up search space (M-WSS) are scheduled by the base station to occur in a same slot, selecting either the scheduled MSS or the scheduled M-WSS for searching in the slot based on a wake-up signal (WUS) search space collision strategy in response to determining that the MSS and the M-WSS are scheduled by the base station to occur in a same slot, and monitoring a Physical Downlink Control Channel (PDCCH) for the selected one of either the scheduled MSSs or the scheduled M-WSS in the slot.

### BACKGROUND

Long Term Evolution (LTE), fifth generation (5G) new radio (NR), and other recently developed communication technologies allow wireless devices to communicate information at data rates (e.g., in terms of Gigabits per second, etc.) that are orders of magnitude greater than what was available just a few years ago. These and other recent improvements have facilitated the emergence of new technologies, such as Internet of Things (IOT) devices, etc.

### SUMMARY

Various aspects include systems and methods for managing multicast communications between a wireless device and a base station. Various aspects include methods that may be performed by a processor of a wireless device or a processor of a base station. Various aspects may include determining whether a multicast search space (MSS) and a multicast wake-up search space (M-WSS) are scheduled by the base station to occur in a same slot, and in response to determining that the MSS and the M-WSS are scheduled by the base station to occur in a same slot, selecting for searching in the slot either the scheduled MSS or the scheduled M-WSS based on a priority assigned to MSS and M-WSS in a wake-up signal (WUS) search space collision strategy, and monitoring a Physical Downlink Control Channel (PDCCH) for the selected one of either the scheduled MSSs or the scheduled M-WSS in the slot. Some aspects may further include allocating any remaining processing capability in the PDCCH slot to monitoring the unselected one of the scheduled MSS or the scheduled M-WSS. In some aspects, the WUS search space collision strategy may include prioritizing any scheduled MSSs over the scheduled M-WSS in the slot.

Some aspects may further include receiving a search space configuration message from the base station, wherein the search space configuration message indicates the scheduled MSS, the scheduled M-WSS, and assigned search space identifiers (SS IDs) for the scheduled MSS and the scheduled M-WSS, wherein the WUS search space collision strategy includes prioritizing the scheduled MSS and the scheduled M-WSS in the slot based on their respective assigned SS IDs.

Some aspects may further include receiving the WUS search space collision strategy from the base station. Some aspects may further include sending an indication of a power saving strategy for the wireless device to the base station, in which receiving the WUS search space collision strategy from the base station includes receiving the WUS search space collision strategy from the base station in response to sending the indication of the power saving strategy. In some aspects, the signaling message may be sent in a Radio Resource Control (RRC) signaling message, a Media Access Control (MAC) Control Element (CE) (MAC CE) message, or a physical-layer control information message. In some aspects, the indication of a power saving strategy may be an indication of a high power mode, and the WUS search space collision strategy may include monitoring all on-durations in a current multicast-WUS (M-WUS) cycle in response to the scheduled M-WSS not being allocated processing capability in the PDCCH slot. In some aspects, the indication of a power saving strategy may be an indication of a low power mode and the WUS search space collision strategy may include indicating to the base station multicast data PDCCH is dropped due to insufficient processing capability in response to the scheduled M-WSS not being allocated processing capability in the PDCCH slot and hybrid Automatic Repeat Request (ARQ) (HARQ) for a corresponding multicast session being activated.

Further aspects may include a wireless device having a processor configured to perform one or more operations of any of the methods summarized above. Further aspects may include processing devices for use in a wireless device configured with processor-executable instructions to perform operations of any of the methods summarized above. Further aspects may include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device and that includes a processor configured to perform one or more operations of any of the methods summarized above.

Various aspects may include a processor of a base station scheduling MSSs for each of a plurality of multicast sessions to be provided to the wireless device, scheduling one M-WSS for the plurality of multicast sessions, determining a relative priority among the scheduled MSSs and the scheduled M-WSS, assigning search space identifiers (SS IDs) to each of the MSSs and the M-WSS based on the determined relative priority, in which each assigned SS ID indicates the determined relative priority of that respective MSSs or M-WSS, generating a search space configuration message indicating the scheduled MSSs, the scheduled M-WSS, and the respective assigned SS IDs, sending the search space configuration message to the wireless device, and sending multicast wake-up downlink control information (DCI) in the M-WSS and multicast data DCI in the corresponding MSSs.

Some aspects may further include determining a WUS search space collision strategy for use by the wireless device, and indicating the WUS search space collision strategy to the wireless device. In some aspects, the WUS search space collision strategy may include prioritizing all scheduled MSSs over the scheduled M-WSS in a slot. In some aspects, the WUS search space collision strategy may include prioritizing the scheduled MSSs and the scheduled M-WSS in a slot based on the respective assigned SS IDs.

Some aspects may further include receiving an indication of a power saving strategy from the wireless device, in which determining the WUS search space collision strategy for use by the wireless device includes determining the WUS search space collision strategy for use by the wireless device based at least in part on the received indication of the power saving strategy.

Further aspects may include a base station having a processor configured to perform one or more operations of any of the methods summarized above. Further aspects may include processing devices for use in a base station configured with processor-executable instructions to perform operations of any of the methods summarized above. Further aspects may include a non-transitory processor-readable storage medium having stored thereon processor-executable instructions configured to cause a processor of a base station to perform operations of any of the methods summarized above. Further aspects include a base station having means for performing functions of any of the methods summarized above. Further aspects include a system on chip for use in a base station and that includes a processor configured to perform one or more operations of any of the methods summarized above.

### BRIEF DESCRIPTION OF THE DRAWINGS

FIG. 1 is a system block diagram illustrating an example communications system suitable for implementing various embodiments.

FIG. 2 is a component block diagram illustrating an example computing system and wireless modem suitable for implementing various embodiments.

FIG. 3 is a component block diagram illustrating a software architecture including a radio protocol stack for the user and control planes in wireless communications suitable for implementing various embodiments.

FIG. 4 is a timing diagram illustrating example collisions between a multicast wake-up search space (M-WSS) and multicast search spaces (MSSs) for a plurality of multicast sessions.

FIG. 5A is a process flow diagram illustrating a method for managing multicast communications with a wireless device in accordance with various embodiments.

FIG. 5B is a process flow diagram illustrating a method for managing multicast communications with a base station in accordance with various embodiments.

FIG. 5C is a block diagram illustrating two example wake-up signal search space collision strategies in accordance with various embodiments.

FIG. 5D is a process flow diagram illustrating a method for managing multicast communications with a base station in accordance with various embodiments.

FIG. 5E is a process flow diagram illustrating a method for managing multicast communications with a base station in accordance with various embodiments.

FIG. 5F is a process flow diagram illustrating a method for managing multicast communications with a base station in accordance with various embodiments.

FIG. 5G is a process flow diagram illustrating a method for managing multicast communications with a wireless device in accordance with various embodiments.

FIG. 6 is a component block diagram of a network computing device suitable for use with various embodiments.

FIG. 7 is a component block diagram of a wireless communication device suitable for use with various embodiments.

FIG. 8 is a component block diagram of an IoT device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include systems and methods for managing multicast communications. Various embodiments may enable a wireless device to prioritize between searching a multicast data search space and searching a multicast wake-up signal (WUS) search space of the Physical Downlink Control Channel (PDCCH) when the multicast data search space and multicast WUS search space “collide” by being scheduled in a same slot by a base station. By enabling the prioritization between searching a multicast data search space and searching a multicast WUS search space during a collision of the search spaces, various embodiments may enable an embodiment wireless device to reduce power consumption in comparison to conventional wireless devices because an embodiment wireless device only needs to expend PDCCH processing capability on one of the search spaces, such as either the multicast data search space or the multicast WUS search space, during the collision of the search spaces, i.e., in slots in which an MSS and an M-WSS are scheduled by the base station to occur in a same slot. Additionally, by enabling the prioritization between searching a multicast data search space and searching a multicast WUS search space during a collision of the search spaces, various embodiments may enable a higher priority multicast session to have guaranteed throughput during the collision of the search spaces as the search space associated with the higher priority, such as either the multicast data search space or the multicast WUS search space, because an embodiment wireless device may ensure PDCCH processing capability is used for the search space associated with the higher priority.

The term “wireless device” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), IEEE 802.11 (WiFi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in various examples.

As used herein, the term “RF chain” refers to the components in a communication device that send, receive, and decode radio frequency signals. An RF chain typically includes a number of components coupled together that transmit RF signals that are referred to as a “transmit chain,” and a number of components coupled together that receive and process RF signals that are referred to as a “receive chain.”

The term “IoT device” is used herein to refer to any of a variety of devices including a processor and transceiver for communicating with other devices or a network. For ease of description, examples of IoT devices are described as communicating via radio frequency (RF) wireless communication links, but IoT devices may communicate via wired or wireless communication links with another device (or user), for example, as a participant in a communication network, such as the IoT. Such communications may include communications with another wireless device, a base station (including a cellular communication network base station and an IoT base station), an access point (including an IoT access point), or other wireless devices.

In Fifth Generation (5G) New Radio (NR) systems, new services and types of wireless devices are being explored. Especially in IOT device use cases, such as smart wearable devices, industrial sensors, video surveillance devices, etc., efforts are being explored to provide 5G NR services to wireless devices that have lower costs to manufacture and reduced capabilities in comparison to typical smart phones. For example, such reduced capability wireless devices are sometimes referred to as reduced-capability (RedCap) user equipments (UEs) (RedCap UEs) or NR-light UEs, and often have reduced numbers of antennas, reduced transmit (Tx)/receive (Rx) bandwidth capabilities, limited battery capacity, and/or reduced processing capability for Physical Downlink Control Channel (PDCCH) blind decoding in comparison to typical 5G NR capable smart phones. Providing 5G NR services to such reduced capability wireless devices (e.g., RedCap UEs, NR-light UEs, etc.) presents challenges as the reduced capability wireless devices (e.g., RedCap UEs, NR-light UEs, etc.) may not have the processing capability, specifically may not have the Physical Downlink Control Channel (PDCCH) processing capability, of typical smart phones.

One aspect of 5G NR services that may present a challenge to wireless devices, especially reduced capability wireless devices (e.g., RedCap UEs, NR-light UEs, etc.), is multicast communication management. In 5G NR, multiple multicast sessions may be used to deliver multicast traffic to a wireless device. Monitoring the PDCCH for multiple multicast sessions may use a large amount of power as PDCCH processing capabilities may need to be assigned by the wireless device to each multicast session. Specifically, in 5G NR systems, a search space (also referred to simply as a SS) may be assigned to each multicast session and multiple search spaces may be assigned to each slot.

Generally, a wireless device in 5G NR systems may support multiple search spaces divided into two types, common search spaces (CSSs) and UE specific search spaces (USSs). In CSSs, the wireless device may search for downlink control information (DCI) messages to receive System Information Block (SIB) messages, Random Access Channel (RACH) messages (e.g., RACH 2 message, RACH 4 message, etc.), paging messages, and/or cell-specific signaling. In USSs, the wireless device may search for DCI messages to receive wireless device specific Physical Downlink Shared Channel (PDSCH) information.

A wireless device may have a certain PDCCH processing capability that may be related to the hardware configuration of the wireless device, such as a number of antennas on the wireless device, modem processor capabilities of the wireless device, bandwidth capabilities of the wireless device, battery capacity of the wireless device, etc. The PDCCH processing capability of the wireless device may control define a maximum number of PDCCH candidates and a maximum number of non-overlapping Control Channel Elements (CCEs) per slot that the wireless device may support. When a wireless device is configured to search multiple search spaces in one slot, the search spaces that can be searched in that slot may be determined based on the wireless device's PDCCH processing capability and a priority among the search spaces for the slot. Generally, wireless devices may be configured such that a higher priority is given to CSSs than USSs. As such, PDCCH processing capability may be allocated to all CSSs first and any remaining PDCCH processing capability may be allocated to USSs by search space identifier (ID) (SS ID) number where smaller index value USSs are allocated first until all USSs are allocated or a maximum number of PDCCH candidates or maximum by number of non-overlapping CCEs is reached.

In 5G NR systems, each multicast session may have its own Group-Radio Network Temporary Identifier (G-RNTI) and discontinuous reception (DRX) profile, such as a respective cycle period, offset, on-duration length, inactivity-timer length, etc. A wireless device attempting to receive multiple multicast sessions may need to monitor the PDCCH at all the on-duration occasions of the different DRX profiles of each multicast session. Monitoring the PDCCH at all the on-duration occasions of the different DRX profiles of each multicast session may consume a large amount of power, especially for reduced capability wireless devices (e.g., RedCap UEs, NR-light UEs, etc.). In scenarios in which there is no multicast traffic in the on-duration, the power used to monitor the PDCCH may be considered to have been wasted.

One solution that may be implemented in 5G NR systems to reduce wasted efforts in monitoring the PDCCH for multiple multicast sessions may include using PDDCH-based wake-up signals (WUSs) to enable wireless devices to skip monitoring sessions for the multicast sessions. In some DRX mode implementations, a wireless device may receive a WUS from a base station (e.g., a gNB) outside of the DRX cycle. The WUS may be a downlink control information (DCI) message, such as WUS message having a DCI format 2_6 with a cyclic redundancy check (CRC) scrambled by Packet Switched Radio Network Temporary Identifier (PS-RNTI), indicating whether or not there is a PDCCH message to be transmitted from the base station to the wireless device in the next on-duration period of the next DRX cycle. A WUS message may be less complex than other forms of DCI message by including one bit of information the state of which indicates whether or not there is a PDCCH message to be transmitted from the base station to the wireless device in the next on-duration period of the next DRX cycle. The WUS message may require less resources to receive and decode than a PDCCH message to be transmitted from the base station to the wireless device in an on-duration period of a DRX cycle. The base station may schedule WUS monitoring occasions for a DRX cycle during which the wireless device is to receive a WUS message prior to the start of the DRX cycle. In response to the WUS message received in a WUS monitoring occasion indicating there is not a PDCCH message to be transmitted from the base station to the wireless device in the next on-duration period of the next DRX cycle, the wireless device may not power on, or otherwise activate, its receiver chains in the next on-duration period of the next DRX cycle. In response to the WUS message indicating there is a PDCCH message to be transmitted from the base station to the wireless device in the next on-duration period of the next DRX cycle, the wireless device may power on, or otherwise activate, its receiver chains in the next on-duration period of the next DRX cycle to receive the PDCCH message. A WUS message may be shared by a group of wireless devices, such as a multicast group of wireless devices, and may be monitored for by wireless devices in CSSs. A WUS message may indicate the dormancy behavior of multiple secondary cell (SCell) groups, such as five SCell groups.

In some implementations of WUS messages for 5G NR systems, the WUS message of one multicast session may include the wake-up indication for all other multicast sessions available from the base station. In this manner, a wireless device may need to receive only one WUS message of only one multicast session. The interval between two adjacent multicast-WUS (M-WUS) occasions of the same multicast session may be referred to as the M-WUS cycle of that multicast session, which may represent the time from the first slot of a current M-WUS occasion to the last slot before the next M-WUS occasion for that multicast session. The WUS messages for multiple multicast sessions may be associated with one or multiple multicast-PS-RNTI values and the wireless device may be required to only receive one WUS message to determine whether monitoring of the PDCCH for each of the multiple multicast sessions may be needed in the next on-duration period of each respective multicast session.

While a common WUS message for multiple multicast sessions may reduce wireless device power consumption in some instances, there is a possibility that the WUS occasion of one multicast session collides with (e.g., occurs in the same slot), as the on-duration of another multicast session. In a WUS occasion, the wireless device monitors the PDCCH to receive a WUS message. In an on-duration, the wireless device monitors the PDCCH to receive unicast or multicast data. As such, when a WUS occasion collides with an on-duration, a wireless device is expected to monitor both of these two kinds of PDCCHs, which greatly increases the number of blind decoding attempts and the number of decoded non-overlapping CCEs required. Such increase of PDCCH monitoring may negatively impact the operations of a wireless device, especially a reduced capability wireless device (e.g., RedCap UE, NR-light UE, etc.). Specifically, a reduced capability wireless device (e.g., RedCap UE, NR-light UE, etc.) may be need to select one of either the search space set for the WUS message in the WUS occasion or the search space set for the multicast data in the on-duration when the WUS occasion and on-duration collide.

Choosing the wrong PDCCH monitoring priority between multicast data and multicast wake-up signals may lead to degraded multicast throughput and/or wasted wireless device power consumption. However, in current 5G NR systems, wireless devices cannot prioritize among PDCCH monitoring for multicast data and PDCCH monitoring for multicast wake-up signals because both multicast data and multicast wake-up signals are associated with CSSs which have the same priority.

Various embodiments may enable a wireless device to prioritize between searching a multicast data search space and searching a multicast wake-up signal (WUS) search space of the Physical Downlink Control Channel (PDCCH) when the multicast data search space and multicast WUS search space collide. In various embodiments, a base station (e.g., a gNB) may configure the priority between the search space of multicast data and the search space of multicast WUS. In various embodiments, the priority may be configured by a WUS search space collision strategy that may control how a wireless device allocates PDCCH processing capabilities when a multicast search space and a multicast WUS search space collide in a slot.

Various embodiments may include a base station (e.g., a gNB) scheduling multicast search spaces (MSSs) for each of a plurality of multicast sessions to be provided to the wireless device. MSSs may be CSSs in which multicast data for the multicast data for the multicast sessions may be transmitted by the base station. Each multicast session of the plurality of multicast session may have its own respective MSS. The MSS for each multicast session may repeat at a periodicity for the DRX cycle of that multicast session. A MSS may be a CSS common to all wireless devices served by the base station. A MSS may have a search space identifier (SS ID) assigned by the base station (e.g., the gNB). In various embodiments, a DCI format may be assigned for MSSs.

Various embodiments may include a base station (e.g., a gNB) scheduling one multicast wake-up search space (M-WSS) for the plurality of multicast sessions. A M-WSS may be a type of CSS that may have a different priority than other types of CSSs, such as CSSs with System Information Radio Network Temporary Identifiers (SI-RNTIs), CSSs with Paging Radio Network Temporary Identifiers (P-RNTIs), etc. A M-WSS may be configured in a primary cell or secondary cell. A M-WSS may have a SS ID assigned by the base station (e.g., the gNB). In various embodiments, the M-WSS may have a unique SS ID and the MSSs the M-WSS is providing WUS support for may also be assigned unique SS IDs. In various embodiments, a DCI format may be assigned for the M-WSS. For example, the DCI format may be “multicast-PS-RNTI.”

In various embodiments, a wireless device, such as a reduced capability wireless device (e.g., RedCap UE, NR-light UE, etc.), may determine whether a M-WSS collides with one or more MSSs in a slot. In response to determining that a M-WSS and a MSS will collide in a slot, the wireless device may determine the priorities of the M-WSS and the MSS that will collide in the slot and may allocate PDCCH processing capability in the slot to either the M-WSS or the MSS based on the relative priority. In various embodiments, the selection of the M-WSS or the MSS based on the relative priority may be based on the WUS search space collision strategy. In some embodiments, the WUS search space collision strategy may be determined by the wireless device itself. In some embodiments, the WUS search space collision strategy may be signaled to the wireless device by the base station (e.g., the gNB).

In various embodiments, the PDCCH processing capability of the wireless device may be first allocated to the higher priority one of the MSS and the M-WSS. In various embodiments, MSSs may be assigned absolute higher priorities than a M-WSS such that MSSs are always prioritized over a M-WSS. In some embodiments, multiple MSSs may be prioritized among themselves based on their respective SS IDs. In embodiments in which MSSs may be assigned absolute higher priorities than a M-WSS, regardless of the prioritization among the MSSs themselves, any MSS may be handled by the wireless device as having higher priority than a M-WSS when a collision with the M-WSS occurs, i.e., when an MSS and an M-WSS occur in a same slot. In various embodiments, each individual MSS and the M-WSS may have relative priorities to one another and may be handled jointly for prioritization based on their respective SS IDs. In such joint prioritization embodiments, the M-WSS may have a higher priority than a given MSS and when the M-WSS and a MSS collide in a slot the M-WSS may be allocated PDCCH processing capability of the wireless device when the M-WSS has the higher priority than the MSS.

In various embodiments, a base station (e.g., a gNB) may send a search space configuration message to a wireless device, such as a reduced capability wireless device (e.g., RedCap UE, NR-light UE, etc.). The search space configuration message may be sent in any suitable signaling message from the base station to a wireless device, such as Radio Resource Control (RRC) signaling messages, Media Access Control (MAC) Control Element (CE) (MAC CE) messages, DCI messages, and/or combinations of the same. The search space configuration message may indicate the scheduled MSSs for each of a plurality of multicast sessions to be provided to the wireless device, the scheduled M-WSS for the plurality of multicast sessions, and the respective assigned SS IDs of the MSSs and the M-WSS. In various embodiments, the base station (e.g., the gNB) may determine a relative priority among the MSSs and the M-WSS. In various embodiments, the assigned SS IDs may indicate the determined relative priority. For example, smaller (or lower) SS ID values may indicate a higher priority. As a specific example, a MSS with the SS ID of “1” may have a higher priority than a M-WSS with the SS ID of “2” and both the MSS with the SS ID of “1” and the M-WSS with the SS ID of “2” may both have a higher priority than a MSS with a SS ID of “3”. The relative priority among the M-WSS and the MSSs may enable the base station to ensure that the wireless devices allocate PDCCH processing capabilities to the highest priority MSS or M-WSS of a highest priority multicast session when there is a collision in a slot thereby ensuring the multicast data of the highest priority multicast session maintains a higher data throughput than other lower priority multicast sessions.

In various embodiments, a wireless device, such as a reduced capability wireless device (e.g., RedCap UE, NR-light UE, etc.), may receive a search space configuration message from a base station (e.g., a gNB) and determine which MSSs and M-WSS should be searched for each slot. In various embodiments, a wireless device, such as a reduced capability wireless device (e.g., RedCap UE, NR-light UE, etc.) may determine whether an MSS and an M-WSS are scheduled by the base station to occur in a same slot (i.e., a collision of an MSS and an M-WSS will occur in a slot). In various embodiments, the wireless device may select either the scheduled MSS or the scheduled M-WSS for searching in the slot based on a WUS search space collision strategy in response to determining that the MSS and the M-WSS are scheduled by the base station to occur in a same slot. In some embodiments, the WUS search space collision strategy may be configured to prioritize any scheduled MSSs over the scheduled M-WSS in the slot. In some embodiments, the WUS search space collision strategy may be configured to prioritize the scheduled MSS and the scheduled M-WSS in the slot based on their respective assigned SS IDs. In some embodiments, the WUS search space collision strategy may be determined based on the power saving strategy of the wireless device. In some embodiments, the wireless device may determine its own WUS search space collision strategy. In some embodiments, the WUS search space collision strategy may be determined by the base station (e.g., a gNB). In some embodiments, the wireless device may indicate its respective power saving strategy to the base station and the base station may determine the WUS search space collision strategy based on the power saving strategy of the wireless device. In some embodiments, the indication of the power saving strategy for the wireless device may be sent in an RRC signaling message, a MAC CE message, a physical-layer control message, a DCI message, or combinations thereof.

In various embodiments, the base station may send multicast wake-up DCI in the M-WSS and multicast data DCI in the corresponding MSSs. In various embodiments, the wireless device may monitor a PDCCH for the selected one of either the scheduled MSS or the scheduled M-WSS in the slot when the scheduled MSS and the scheduled M-WSS collide. For example, the wireless device may search the selected M-WSS or the selected MSS by blind decoding for the current slot and decode the corresponding DCIs of either the selected M-WSS or the selected MSS that was searched. The base station may further transmit multicast PDSCHs based on the sent multicast data DCIs and the wireless device may receive the multicast PDSCHs based on the decoded DCIs.

In various embodiments, a WUS search space collision strategy may prioritize all scheduled MSSs over a scheduled M-WSS in a slot when a wireless device is in a high power mode (or non-power-saving strategy), such as when the wireless device is connected by a power cable to a power source, has a high capacity battery, or a battery charge is above a minimum threshold. In some embodiments, the wireless device may indicate to the base station that the wireless device is in a high power mode (or non-power-saving strategy) in advance of the base station scheduling multicast sessions. Such prioritization of all scheduled MSSs over a scheduled M-WSS in a slot may be a non-power-saving-prioritized strategy. As an example, of such a non-power-saving-prioritized strategy, the wireless device may be configured such that the wireless device prioritizes all the MSSs over the M-WSS in PDCCH prioritization, (e.g., when PDCCH processing capability is allocated, all the MSSs are allocated prior to M-WSS). In this manner, if the M-WSS is not allocated with PDCCH processing capability, the wireless device will monitor all on-durations in the current M-WUS cycle. Such all on-duration monitoring may increase the wireless device's multicast throughput, but because all on-durations are monitored, though some of them may have no traffic, all on-duration monitoring may cause the wireless device to consume more unnecessary power in PDCCH monitoring. In some embodiments, the indication of a power saving strategy sent by the wireless device to a base station may be an indication of a high power mode and the WUS search space collision strategy may include monitoring all on-durations in a current M-WUS cycle in response to the scheduled M-WSS not being allocated processing capability in the PDCCH slot.

In various embodiments, a WUS search space collision strategy may jointly prioritize all the MSSs and the M-WSS in PDCCH prioritization based on their respective priorities, such as their respective SS ID values or other forms of priorities assigned to the MSSs and the M-WSS. Joint prioritization of all the MSSs and the M-WSS may be a power-saving-prioritized strategy used when the wireless device is in low power mode (or power-saving strategy), such as not connected to a power cable, has a low capacity battery, or the battery charge is below a threshold. In some embodiments, the wireless device may indicate to the base station that the wireless device is in a low power mode (or power-saving strategy) in advance of the base station scheduling multicast sessions. Based on the joint prioritization of all the MSSs and the M-WSS, should the M-WSS not be allocated with PDCCH processing capability, the wireless device may monitor all on-durations in the current WUS cycle. Based on the joint prioritization of all the MSSs and the M-WSS, should a low-priority MSS not be allocated with PDCCH processing capability and hybrid Automatic Repeat Request (ARQ) (HARQ) for the correspond multicast session be activated, the wireless device may report an indication of the wireless device dropping multicast data PDCCH due to insufficient PDCCH processing capability to the base station (e.g., the gNB). Joint prioritization of all the MSSs and the M-WSS may reduce the wireless device's power consumption while supporting the throughput of a high-priority multicast session, though potentially at the expense of decreasing the throughput of lower-priority multicast sessions. In some embodiments, an indication of a power saving strategy for the wireless device sent to a base station may be an indication of a low power mode, and the WUS search space collision strategy may include indicating to the base station that multicast data PDCCH is dropped due to insufficient processing capability in response to the scheduled M-WSS not being allocated processing capability in the PDCCH slot and HARQ for a corresponding multicast session being activated.

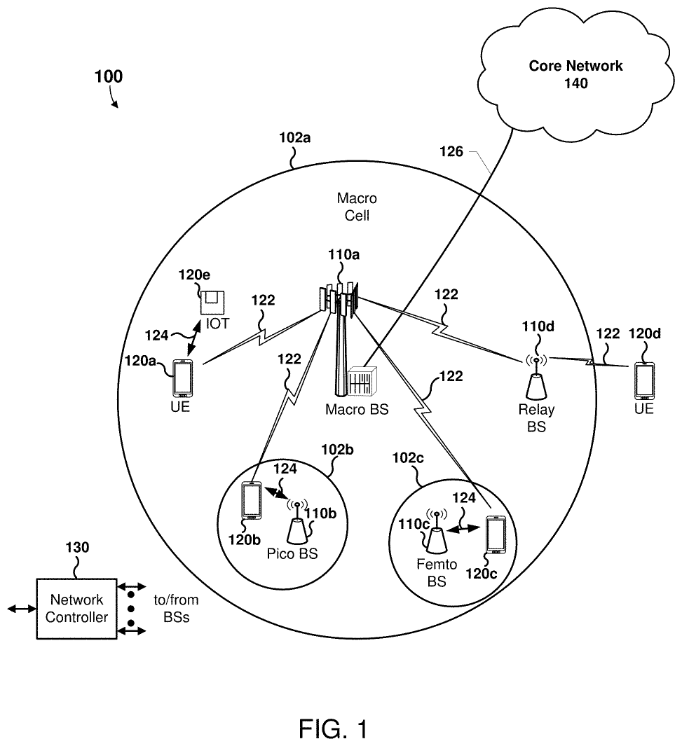

FIG. 1 shows a system block diagram illustrating an example communications system. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as wireless devices 120a-120d and IoT device 120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a Radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported.

Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices (for example, illustrated as the wireless device 120a and the IoT device 120e) may communicate directly using one or more sidelink channels (for example, without using a base station 110a-d as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

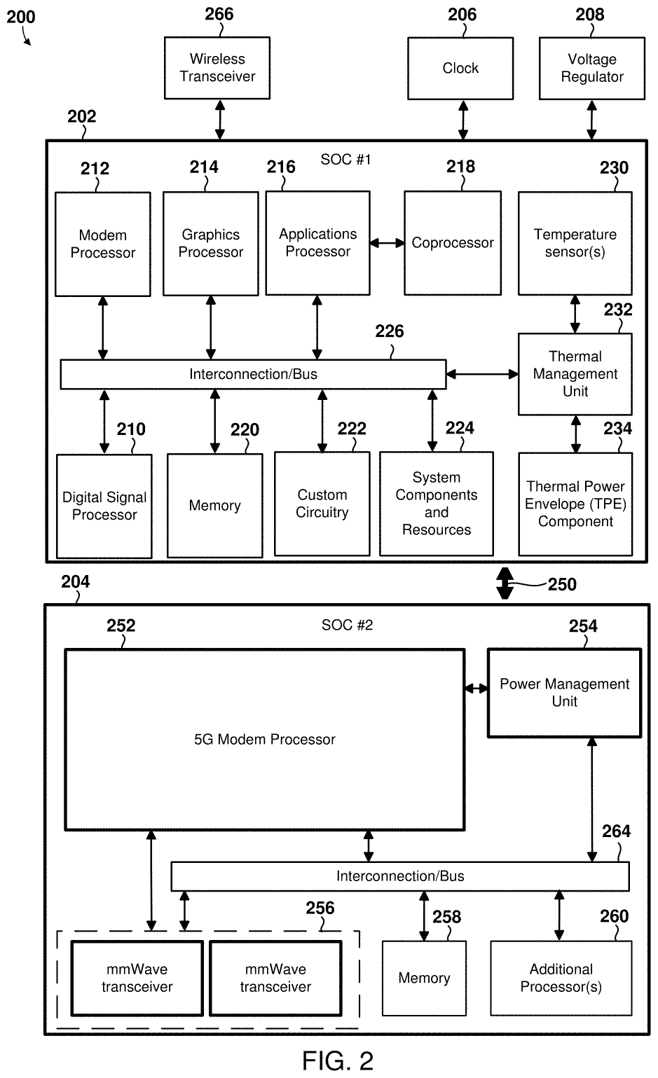

FIG. 2 is a component block diagram illustrating an example computing and wireless modem system 200 suitable for implementing various embodiments. Various embodiments may be implemented on a number of single processor and multiprocessor computer systems, including a system-on-chip (SOC) or system in a package (SIP).

With reference to FIGS. 1 and 2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from wireless devices, such as a base station 110a. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz millimeter wave (mmWave) spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

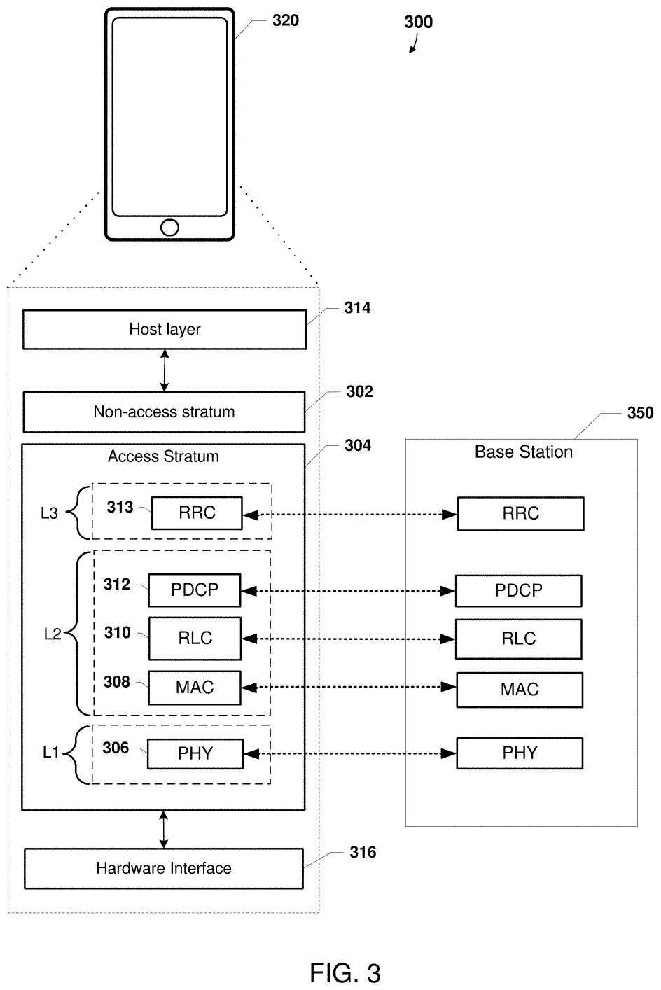

FIG. 3 is a component block diagram illustrating a software architecture 300 including a radio protocol stack for the user and control planes in wireless communications suitable for implementing various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

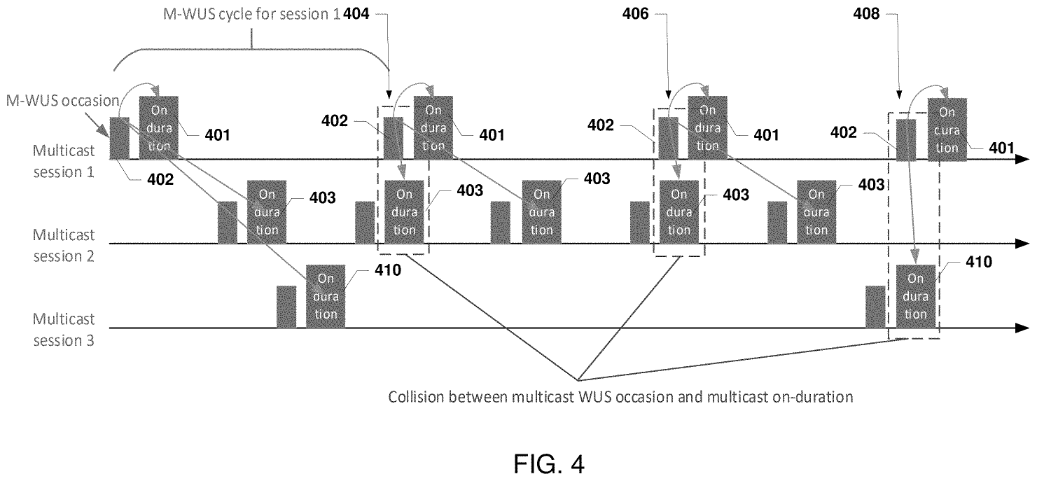

FIG. 4 is a timing diagram illustrating example collisions between a multicast wake-up search space (M-WSS) and multicast search spaces (MSSs) for a plurality of multicast sessions, multicast session 1, multicast session 2, and multicast session 3. With reference to FIGS. 1-4, the M-WUS occasion for the multicast session 1, may correspond to a M-WSS 402. The M-WSS 402 may provide a WUS signal for the other two multicast sessions, multicast session 2 and multicast session 3. The WUS signal received in the M-WSS 402 may indicate the state of whether or not a wireless device (e.g., wireless device 120a-120e, 200, 320) may be need to observe the on duration for multicast session 1, the on duration for multicast session 2, and/or the on duration for multicast session 3. The on durations for the multicast sessions 1, 2, and 3 may each correspond to their own respective MSSs, 401, 403, and 410. The periodicity of the MSSs 401, 403, and 410 may be controlled by the periodicity of the DRX or M-WUS cycle for that respective multicast session.

As the different multicast sessions 1, 2, and 3 may have different periodicities, the MSS for multicast session 2 and multicast session 3 may collide with the M-WSS for multicast session 1 in some slots, such as in slots 404, 406, and 408 as illustrated in FIG. 4. In slot 404 the M-WSS 402 collides with the MSS 403. In slot 406 the M-WSS 402 collides again with MSS 403. In the slot 408 the M-WSS 402 collies with the MSS 410. A wireless device (e.g., 120a-120e, 200, 320), such as a reduced capability wireless device (e.g., RedCap UE, NR-light UE, etc.), that does not have sufficient PDCCH processing capabilities to monitor the M-WSS and another MSS in the same slot may need to prioritize between monitoring for the M-WSS 402 or the MSSs 403 or 410 when there is a collision between an MSS 403, 410 and the M-WSS 402 in that slot. Various embodiments may enable a wireless device (e.g., 120a-120e, 200, 320) to prioritize between monitoring for the M-WSS 402 or the MSSs 403 or 410 when there is a collision between an MSS 403, 410 and the M-WSS 402 in that slot.

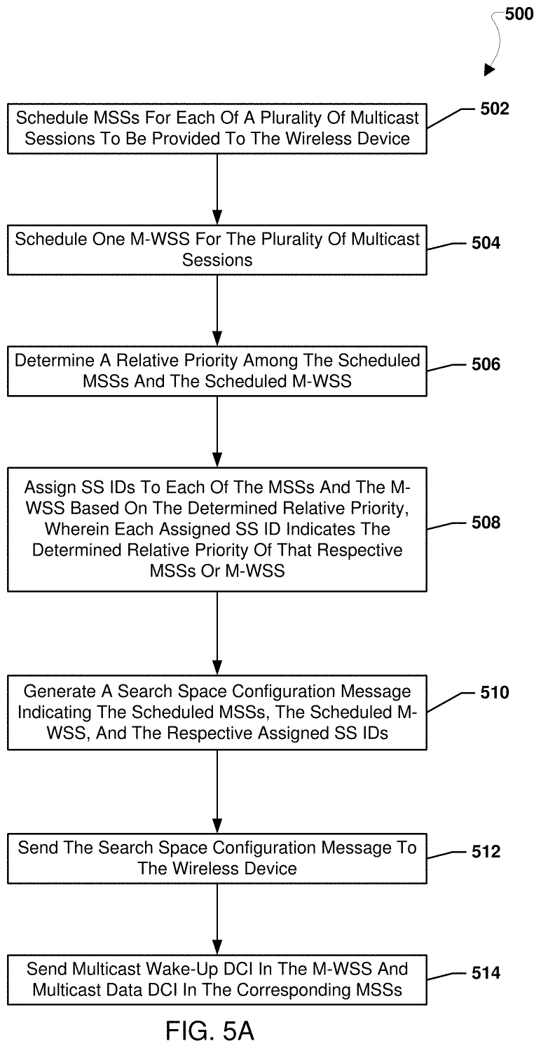

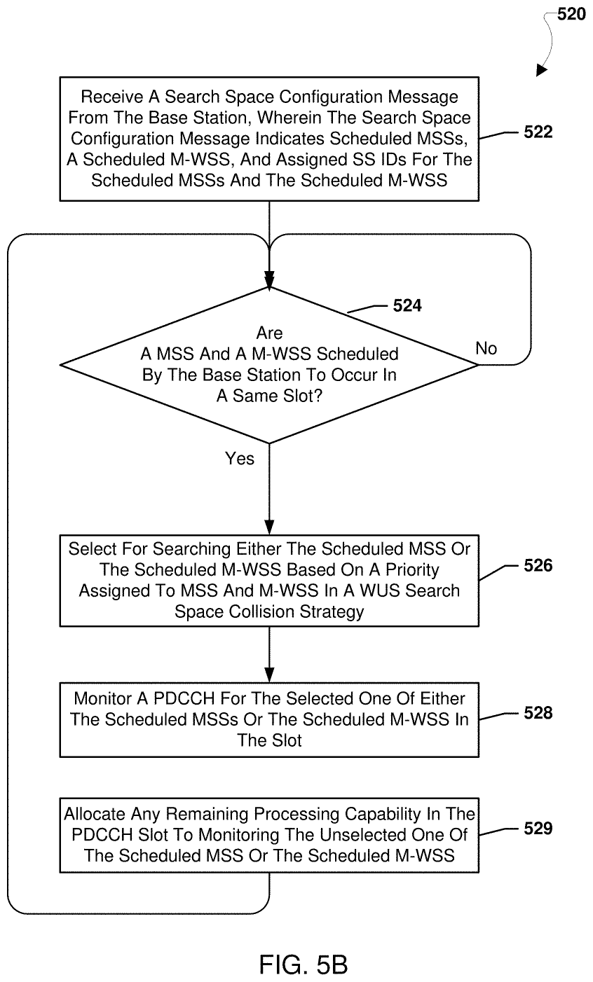

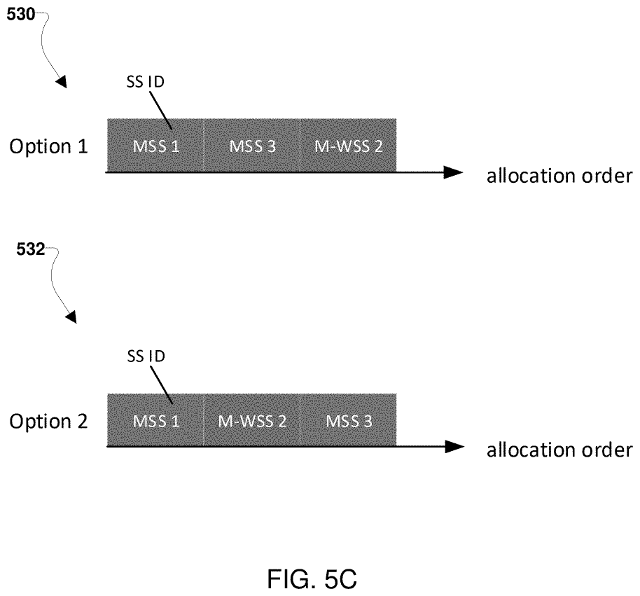

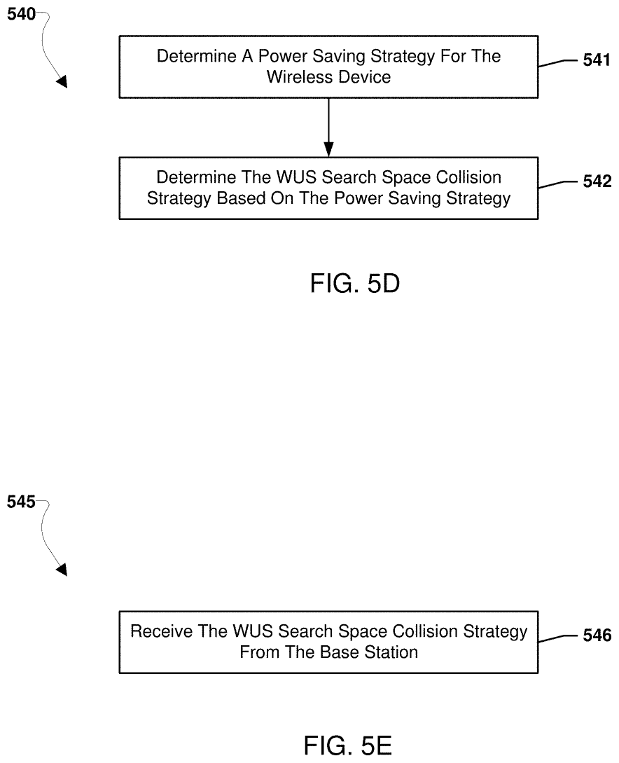

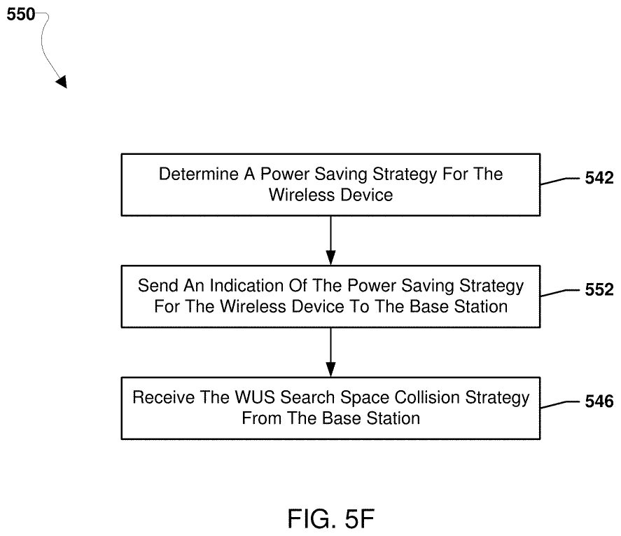

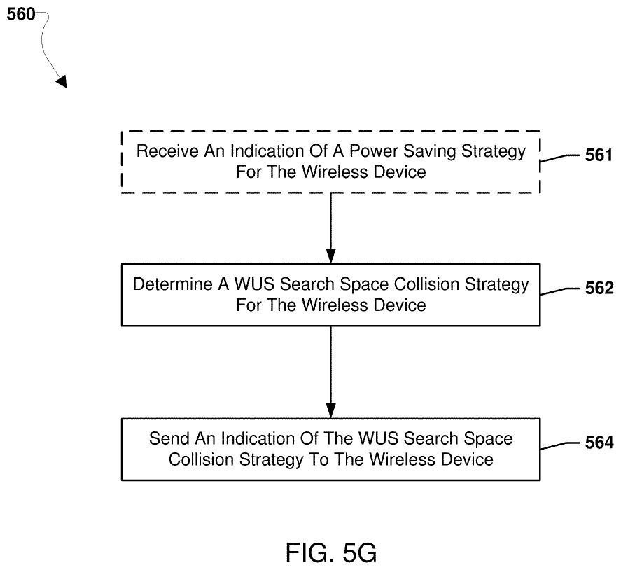

FIG. 5A is a process flow diagram illustrating a method 500 that may be performed by a processor of a base station for managing multicast communications with a wireless device in accordance with various embodiments. With reference to FIGS. 1-5A, the method 500 may be implemented by a processor of a network computing device (e.g., the base station 110a-d, 350).

In block 502, the processor may perform operations including scheduling MSSs for each of a plurality of multicast sessions to be provided to the wireless device. MSSs may be CSSs in which multicast data for the multicast data for the multicast sessions may be transmitted by the base station. Each multicast session of the plurality of multicast session may have its own respective MSS. The MSS for each multicast session may repeat at a periodicity for the DRX cycle of that multicast session. A MSS may be a CSS common to all wireless devices served by the base station. A MSS may have a search space identifier (SS ID) assigned by the base station (e.g., the gNB). In various embodiments, a DCI format may be assigned for MSSs.

In block 504, the processor may perform operations including scheduling one M-WSS for the plurality of multicast sessions. A M-WSS may be a type of CSS that may have a different priority than other types of CSSs, such as CSSs with System Information Radio Network Temporary Identifiers (SI-RNTIs), CSSs with Paging Radio Network Temporary Identifiers (P-RNTIs), etc. A M-WSS may be configured in a primary cell or secondary cell. A M-WSS may have a SS ID assigned by the base station (e.g., the gNB). In various embodiments, the M-WSS may have a unique SS ID and the MSSs the M-WSS is providing WUS support for may also be assigned unique SS IDs. In various embodiments, a DCI format may be assigned for the M-WSS.

In block 506, the processor may perform operations including determining a relative priority among the scheduled MSSs and the scheduled M-WSS. For example, some MSSs may be associated with higher priority multicast sessions and other MSSs may be associated with lower priority multicast sessions. Additionally, the M-WSS may have a lower priority than some MSSs and a higher priority than other MSSs. The base station may determine the relative priority based on priority settings from the network related to each of the multicast sessions for which the MSSs are associated. For example, a highest priority multicast session may be given a highest priority and the M-WSS may be associated with that highest priority multicast session and given the second highest priority. As another example, the priority of all MSSs may be determined to be higher than the M-WSS.

In block 508, the processor may perform operations including assigning SS IDs to each of the MSSs and the M-WSS based on the determined relative priority, wherein each assigned SS ID indicates the determined relative priority of that respective MSSs or M-WSS. For example, smaller (or lower) SS ID values may indicate a higher priority. As a specific example, a MSS with the SS ID of “1” may have a higher priority than a M-WSS with the SS ID of “2” and both the MSS with the SS ID of “1” and the M-WSS with the SS ID of “2” may both have a higher priority than a MSS with a SS ID of “3.”

In block 510, the processor may perform operations including generating a search space configuration message indicating the scheduled MSSs, the scheduled M-WSS, and the respective assigned SS IDs. The search space configuration message may indicate the scheduled MSSs for each of a plurality of multicast sessions to be provided to the wireless device, the scheduled M-WSS for the plurality of multicast sessions, and the respective assigned SS IDs of the MSSs and the M-WSS.

In block 512, the processor may perform operations including sending the search space configuration message to the wireless device. The search space configuration message may be sent in any suitable signaling message from the base station to a wireless device, such as RRC signaling messages, MAC CE messages, DCI messages, and/or combinations of the same.

In block 514, the processor may perform operations including sending multicast wake-up DCI in the M-WSS and multicast data DCI in the corresponding MSSs. In this manner, a WUS may be received by a wireless device via the DCI in the M-WSS and multicast data may be received by a wireless device via the DCI in a MSS.

FIG. 5B is a process flow diagram illustrating a method 520 that may be performed by a processor of a wireless device for managing multicast communications with a base station in accordance with various embodiments. With reference to FIGS. 1-5B, the operations of the method 520 may be performed by a processor (such as the processor 210, 212, 214, 216, 218, 252, 260) of a wireless device (such as the wireless device 120a-120e, 200, 320). In various embodiments, the operations of the method 520 may be performed in conjunction with the operations of the method 500 (FIG. 5A). As a specific example, the operations of the method 520 may be performed be a wireless device that is a reduced capability wireless device (e.g., RedCap UE, NR-light UE, etc.).

In block 522, the processor may perform operations including receiving a search space configuration message from the base station, wherein the search space configuration message indicates scheduled MSSs, a scheduled M-WSS, and assigned SS IDs for the scheduled MSSs and the scheduled M-WSS. The search space configuration message may be received in any suitable signaling message from the base station to the wireless device, such as RRC signaling messages, MAC CE messages, DCI messages, and/or combinations of the same. The search space configuration message may indicate the scheduled MSSs for each of a plurality of multicast sessions to be provided to the wireless device, the scheduled M-WSS for the plurality of multicast sessions, and the respective assigned SS IDs of the MSSs and the M-WSS.

In determination block 524, the processor may perform operations including determining whether an MSS and an M-WSS are scheduled by the base station to occur in a same slot. The processor may determine that a collision of a scheduled MSS and a scheduled M-WSS will occur in a same slot when the M-WSS and the MSS are scheduled for a same slot according to the search space configuration message.

In response to determining that an MSS and an M-WSS are not scheduled by the base station to occur in a same slot (i.e., determination block 524=“No”), the processor may perform operations including continuing to determine whether an MSS and an M-WSS are scheduled by the base station to occur in a same slot in determination block 524.

In response to determining that an MSS and an M-WSS are scheduled by the base station to occur in a same slot (i.e., determination block 524=“Yes”), the processor may perform operations including selecting for searching either the scheduled MSS or the scheduled M-WSS based on a priority assigned to MSS and M-WSS in a WUS search space collision strategy in block 526. In some embodiments, the WUS search space collision strategy may be configured to prioritize any scheduled MSSs over the scheduled M-WSS in the slot. In some embodiments, the WUS search space collision strategy may be configured to prioritize the scheduled MSS and the scheduled M-WSS in the slot based on their respective assigned SS IDs.

In block 528, the processor may perform operations including monitoring a PDCCH for the selected one of either the scheduled MSS or the scheduled M-WSS in the slot. For example, the wireless device may search the selected M-WSS or the selected MSS by blind decoding for the current slot and decode the corresponding DCIs of either the selected M-WSS or the selected MSS that was searched.

In block 529, the processor may perform operations including allocating any remaining processing capability in the PDCCH slot to monitoring the unselected one of the scheduled MSS or the scheduled M-WSS. In some embodiments, the wireless device may have sufficient processing capability that in addition to allocating processing capability to the selected scheduled MSS or scheduled M-WSS, processing capability may be available for allocation to the unselected scheduled MSS or scheduled M-WSS. In such embodiments, the higher priority MSS or M-WSS may be allocated first and after the higher priority MSS or M-WSS is allocated, the lower priority MSS or M-WSS may also be allocated remaining processing capability. In this manner, both the scheduled MSS and the scheduled M-WSS may be allocated processing capability when circumstances permit. In some situations, the processing capability may not be sufficient and only one of the scheduled MSS or the scheduled M-WSS may be allocated PDCCH processing capability.

FIG. 5C is a block diagram illustrating two example WUS search space collision strategies 530 and 532 in accordance with various embodiments. With reference to FIGS. 1-5C, the WUS search space collision strategies 530 and 532 are example WUS search space collision strategies that may be implement as part of the operations of the methods 500 (FIG. 5A) and/or 520 (FIG. 5B). The WUS search space collision strategies 530 and 532 may enable a wireless device (e.g., 120a-120e, 200, 320) to determine priorities of search spaces for a slot when a M-WSS collides with one or more MSSs.

As an example, in a first option that is WUS search space collision strategies 530, two multicast sessions are configured to a wireless device and a respective DRX profile (e.g., including cycle, start offset, on-duration length) is configured for each multicast session. A first multicast session may be associated with a MSS having a SS ID of 1, a second multicast session may be associated with a MSS having a SS ID of 3, and the common M-WSS 2 for both the first multicast session and the second multicast session may be assigned the SS ID of 2 by the base station. In the WUS search space collision strategy 530, all scheduled MSSs are prioritized over the scheduled M-WSS in a slot. Accordingly, the wireless device may determine the priority or allocation order of the MSSs and M-WSS to be MSS 1, MSS 3, and M-WSS 2 as MSSs may be prioritized over M-WSSs without regard to the SS IDs assigned.

As another example, in a second option that is WUS search space collision strategies 532, two multicast sessions are configured to a wireless device and a respective DRX profile (e.g., including cycle, start offset, on-duration length) is configured for each multicast session. A first multicast session may be associated with a MSS having a SS ID of 1, a second multicast session may be associated with a MSS having a SS ID of 3, and the common M-WSS 2 for both the first multicast session and the second multicast session may be assigned the SS ID of 2 by the base station. The base station may assign the SS IDs based on the relative priorities between the first multicast session, the M-WSS, and the second multicast session jointly such that the SS IDs indicate the priority of each, for example from lowest value SS ID being highest priority to highest value SS ID being lowest priority. In the WUS search space collision strategy 532, MSSs and the M-WSS are prioritized by SS ID in a slot. Accordingly, the wireless device may determine the priority or allocation order of the MSSs and M-WSS to be MSS 1, M-WSS 2, and MSS 3 as multicast session 1 may have a high priority and its DCI is sent in MSS 1, while multicast session 2 may have a low priority, and its DCI is sent in MSS 2. The relative priority may be indicated by the base station assigning an SS ID to the two MSSs and the one M-WSS such that the SS ID of MSS 1 is less than the SS ID of the M-WSS which is less than the SS ID of MSS 2. While FIG. 5C illustrates example WUS search space collision strategies 530 and 532 based on SS IDs and/or types, the WUS search space collision strategies 530 and 532 are merely examples of priority indications and other forms of priority indication may be substituted for SS IDs and/or types in various embodiments.

FIG. 5D is a process flow diagram illustrating a method 540 that may be performed by a processor of a wireless device for managing multicast communications with a base station in accordance with various embodiments. With reference to FIGS. 1-5D, the operations of the method 540 may be performed by a processor (such as the processor 210, 212, 214, 216, 218, 252, 260) of a wireless device (such as the wireless device 120a-120e, 200, 320). In various embodiments, the operations of the method 540 may be performed in conjunction with the operations of the methods 500 (FIG. 5A) and/or 520 (FIG. 5B). As a specific example, the operations of the method 540 may be performed be a wireless device that is a reduced capability wireless device (e.g., RedCap UE, NR-light UE, etc.).

In block 541, the processor may perform operations including determining a power saving strategy for the wireless device. In some embodiments, the power saving strategy of the wireless device may be a current power mode set at the wireless device. For example, a power saving strategy maybe a high power mode (or non-power-saving strategy) or a low power mode (or power-saving strategy). The power saving strategy may reflect the current setting or state of the wireless device as to the wireless device's power capacity, such as connected by a power cable to a power source, not connected to a power cable, has a high capacity battery, has a low capacity battery, has a battery charge above a minimum threshold, has a battery charge below a minimum threshold, etc.

In block 542, the processor may perform operations including determining the WUS search space collision strategy based on the power saving strategy. For example, different WUS search space collision strategies may be correlated with different power saving strategies and the processor may select the WUS search space collision strategy correlated to the determined power saving strategy. As an example, when the power saving strategy is determined to be a high power mode, a WUS search space collision strategy that prioritizes all MSSs over the M-WUS may be selected. As another example, when the power saving strategy is determined to be a low power mode, a WUS search space collision strategy that prioritizes MSSs and the M-WUS jointly based on SS IDs may be selected. The determined (or selected) WUS search space collision strategy may be used by the wireless device in the operations of block 526 of the method 520 (FIG. 5B) to select either the scheduled MSS or the scheduled M-WSS for searching in the slot when a collision will occur.

FIG. 5E is a process flow diagram illustrating a method 545 for managing multicast communications with a base station in accordance with various embodiments. With reference to FIGS. 1-5E, the operations of the method 545 may be performed by a processor (such as the processor 210, 212, 214, 216, 218, 252, 260) of a wireless device (such as the wireless device 120a-120e, 200, 320). In various embodiments, the operations of the method 545 may be performed in conjunction with the operations of the methods 500 (FIG. 5A) and/or 520 (FIG. 5B). As a specific example, the operations of the method 545 may be performed be a wireless device that is a reduced capability wireless device (e.g., RedCap UE, NR-light UE, etc.).

In block 546, the processor may perform operations including receiving the WUS search space collision strategy from the base station. The WUS search space collision strategy may be received via initial signaling between the base station and the wireless device to establish a multicast session. The WUS search space collision strategy may be a prioritization indication received from the base station configuring how the wireless device is to prioritize MSSs and the M-WSS when a collision occurs. As an example, the WUS search space collision strategy may prioritize all MSSs over the M-WUS. As another example, the WUS search space collision strategy may prioritize MSSs and the M-WUS jointly based on SS IDs. The received WUS search space collision strategy may be used by the wireless device in the operations of block 526 of the method 520 (FIG. 5B) to select either the scheduled MSS or the scheduled M-WSS for searching in the slot when a collision will occur.

FIG. 5F is a process flow diagram illustrating a method 550 for managing multicast communications with a base station in accordance with various embodiments. With reference to FIGS. 1-5F, the operations of the method 550 may be performed by a processor (such as the processor 210, 212, 214, 216, 218, 252, 260) of a wireless device (such as the wireless device 120a-120e, 200, 320). In various embodiments, the operations of the method 550 may be performed in conjunction with the operations of the methods 500 (FIG. 5A) and/or 520 (FIG. 5B). As a specific example, the operations of the method 550 may be performed be a wireless device that is a reduced capability wireless device (e.g., RedCap UE, NR-light UE, etc.).

In block 542, the processor may perform operations including determining a power saving strategy for the wireless device as described for the same numbered block of the method 540 (FIG. 5D).

In block 552, the processor may perform operations including sending an indication of the power saving strategy for the wireless device to the base station. For example, the wireless device may indicate whether the current power saving strategy is a high power mode (or non-power-saving strategy) or a low power mode (or power-saving strategy). The indication of the power saving strategy for the wireless device may be sent to the base station in initial signaling between the wireless device and base station to establish a multicast session.

In block 546, the processor may perform operations including receiving the WUS search space collision strategy from the base station as discussed above with reference to method 545 (FIG. 5E).

FIG. 5G is a process flow diagram illustrating a method 560 for managing multicast communications with a wireless device in accordance with various embodiments. With reference to FIGS. 1-5G, the method 560 may be implemented by a processor of a network computing device (e.g., the base station 110a-d, 350). In various embodiments, the operations of the method 560 may be performed in conjunction with the operations of the methods 500 (FIG. 5A), 520 (FIG. 5B), 545 (FIG. 5E), and/or 550 (FIG. 5F).

In optional block 561, the processor may perform operations including receiving an indication of a power saving strategy from the wireless device. The indication of the power saving strategy for the wireless device may be received by the base station in initial signaling between the wireless device and base station to establish a multicast session. For example, the indication of the power saving strategy from the wireless device may indicate whether the current power saving strategy for the wireless device is a high power mode (or non-power-saving strategy) or a low power mode (or power-saving strategy). The operations of block 561 may be optional as not all wireless devices may indicate their power saving strategies to the base station.

In block 562, the processor may perform operations including determining a WUS search space collision strategy for the wireless device. In some embodiments, the WUS search space collision strategy for the wireless device may be determined based on the power saving strategy for the wireless device when the power saving strategy for the wireless device is available to the base station (e.g., when received in optional block 561). For example, different WUS search space collision strategies may be correlated with different power saving strategies and the processor may select the WUS search space collision strategy correlated to the determined power saving strategy. As an example, when the power saving strategy is determined to be a high power mode, a WUS search space collision strategy that prioritizes all MSSs over the M-WUS may be selected. As another example, when the power saving strategy is determined to be a low power mode, a WUS search space collision strategy that prioritizes MSSs and the M-WUS jointly based on SS IDs may be selected. In some embodiments, the WUS search space collision strategy may be selected by the base station without input from the wireless device as to the wireless device's power saving strategy. The WUS search space collision strategy may be a prioritization selected by the base station configuring how the wireless device is to prioritize MSSs and the M-WSS when a collision occurs. As an example, the WUS search space collision strategy may prioritize all MSSs over the M-WUS. As another example, the WUS search space collision strategy may prioritize MSSs and the M-WUS jointly based on SS IDs.

In block 564, the processor may send an indication of the WUS search space collision strategy to the wireless device. The indication of the WUS search space collision strategy may be sent by the base station to the wireless device in initial signaling between the wireless device and base station to establish a multicast session.

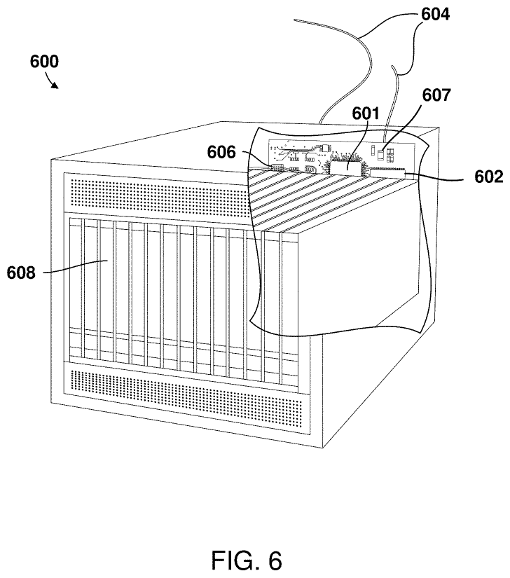

FIG. 6 is a component block diagram of a network computing device suitable for use with various embodiments. Such network computing devices (e.g., base station 110a-110d, 350) may include at least the components illustrated in FIG. 6. With reference to FIGS. 1-6, the network computing device 600 may typically include a processor 601 coupled to volatile memory 602 and a large capacity nonvolatile memory, such as a disk drive 608. The network computing device 600 also may include a peripheral memory access device 606 such as a floppy disc drive, compact disc (CD) or digital video disc (DVD) drive coupled to the processor 601. The network computing device 600 also may include network access ports 604 (or interfaces) coupled to the processor 432 for establishing data connections with a network, such as the Internet or a local area network coupled to other system computers and servers. The network computing device 600 may include one or more antennas 607 for sending and receiving electromagnetic radiation that may be connected to a wireless communication link. The network computing device 600 may include additional access ports, such as USB, Firewire, Thunderbolt, and the like for coupling to peripherals, external memory, or other devices.

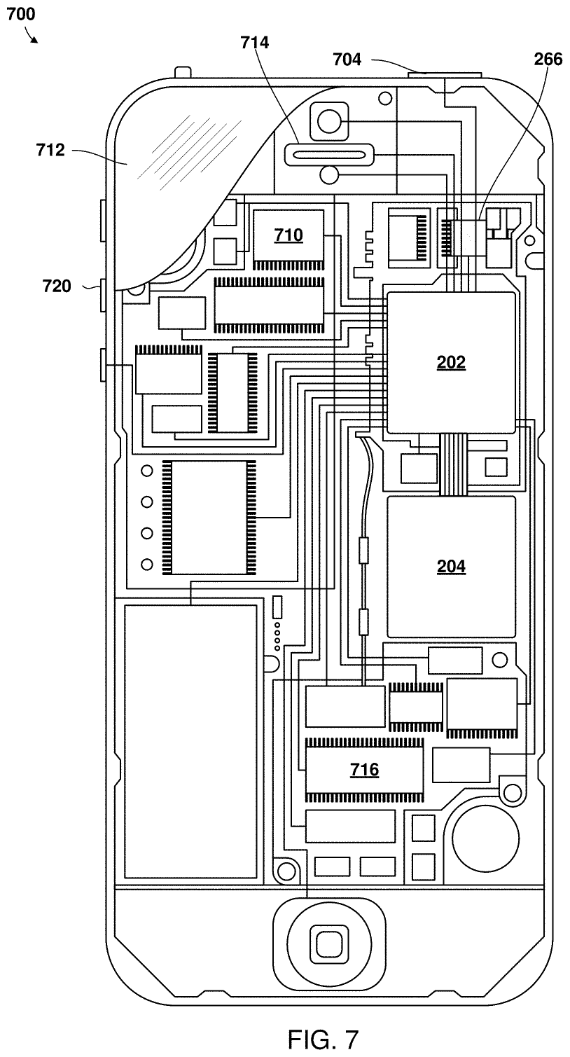

FIG. 7 is a component block diagram of a wireless device 700 suitable for use with various embodiments. With reference to FIGS. 1-7, various embodiments may be implemented on a variety of wireless devices 700 (for example, the wireless device 120a-120e, 200, 320), an example of which is illustrated in FIG. 7 in the form of a smartphone. The wireless device 700 may include a first SOC 202 (for example, a SOC-CPU) coupled to a second SOC 204 (for example, a 5G capable SOC). The first and second SOCs 202, 204 may be coupled to internal memory 716, a display 712, and to a speaker 714. Additionally, the wireless device 700 may include one or more antenna panels 704 (e.g., four panels) each made up of a number of antenna elements (e.g., 4-8 elements) configured for receiving RF signals via digital beamforming as describe herein. The antenna panels 704 may be connected to a wireless transceiver 266 coupled to one or more processors in the first or second SOCs 202, 204. Smartphones 700 typically also include menu selection buttons or rocker switches 720 for receiving user inputs.

A wireless device 700 may also include a sound encoding/decoding (CODEC) circuit 710, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 710 may include a digital signal processor (DSP) circuit (not shown separately).

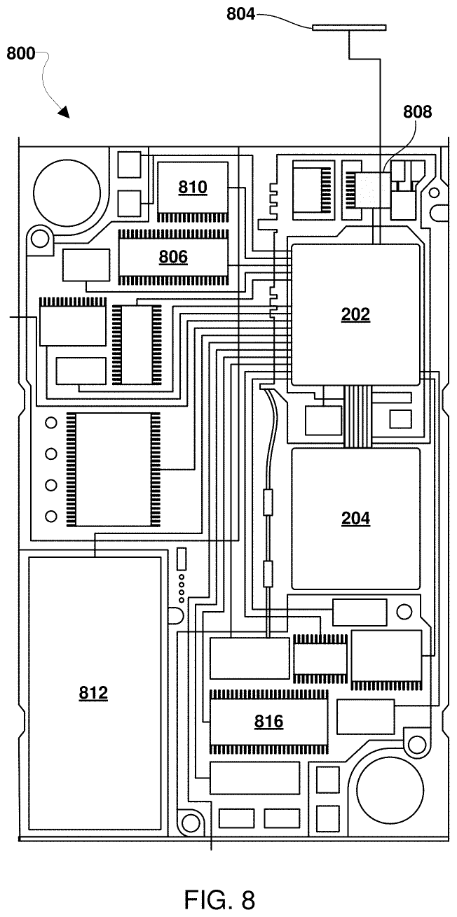

Various embodiments may be implemented on a variety of IoT devices, an example in the form of a circuit board for use in a device is illustrated in FIG. 8. With reference to FIGS. 1-8, an IoT device 800 may include a first SOC 202 (e.g., a SOC-CPU) coupled to a second SOC 204 (e.g., a 5G capable SOC). The first and second SOCs 202, 204 may be coupled to internal memory 806. Additionally, the IoT device 800 may include or be coupled to an antenna 804 for sending and receiving wireless signals from a cellular telephone transceiver 808 or within the second SOC 204. The antenna 804 and transceiver 808 and/or second SOC 204 may support communications using various RATs, including NB-IoT, CIoT, GSM, BlueTooth, Wi-Fi, VoLTE, etc.

A IoT device 800 may also include a sound encoding/decoding (CODEC) circuit 810, which digitizes sound received from a microphone into data packets suitable for wireless transmission and decodes received sound data packets to generate analog signals that are provided to a speaker to generate sound in support of voice or VoLTE calls. Also, one or more of the processors in the first and second SOCs 202, 204, wireless transceiver 808 and CODEC 810 may include a digital signal processor (DSP) circuit (not shown separately).

Some IoT devices may include an internal power source, such as a battery 812 configured to power the SOCs and transceiver(s). Such IoT devices may include power management components 816 to manage charging of the battery 812.

The processors of the network computing device 600, the wireless device 700, and the IoT device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500-560 may be substituted for or combined with one or more operations of the methods 500-560.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method performed by a processor of a wireless device for managing multicast communications with a base station, comprising:
determining whether a multicast search space (MSS) and a multicast wake-up search space (M-WSS) are scheduled by the base station to occur in a same slot; and
in response to determining that the MSS and the M-WSS are scheduled by the base station to occur in a same slot:
selecting for searching in the slot either the scheduled MSS or the scheduled M-WSS based on a priority assigned to MSS and M-WSS in a wake-up signal (WUS) search space collision strategy; and
monitoring a Physical Downlink Control Channel (PDCCH) for at least the selected one of either the scheduled MSSs or the scheduled M-WSS in the slot.

2. The method of claim 1, further comprising allocating any remaining processing capability in the PDCCH slot to monitoring the unselected one of the scheduled MSSs or the scheduled M-WSS.

3. The method of claim 1, wherein the WUS search space collision strategy comprises prioritizing any scheduled MSS over the scheduled M-WSS in the slot.

4. The method of claim 1, further comprising:
receiving a search space configuration message from the base station, wherein the search space configuration message indicates the scheduled MSS, the scheduled M-WSS, and assigned search space identifiers (SS IDs) for the scheduled MSSs and the scheduled M-WSS,
wherein the WUS search space collision strategy comprises prioritizing the scheduled MSS and the scheduled M-WSS in the slot based on their respective assigned SS IDs.

5. The method of claim 1, further comprising:
receiving the WUS search space collision strategy from the base station.

6. The method of claim 5, further comprising:
sending an indication of a power saving strategy for the wireless device to the base station,
wherein receiving the WUS search space collision strategy from the base station comprises receiving the WUS search space collision strategy from the base station in response to sending the indication of the power saving strategy.

7. (canceled)

8. The method of claim 6, wherein:
the indication of a power saving strategy is an indication of a high power mode; and
the WUS search space collision strategy comprises monitoring all on-durations in a current multicast-WUS (M-WUS) cycle in response to the scheduled M-WSS not being allocated processing capability in the PDCCH slot.

9. The method of claim 6, wherein:
the indication of a power saving strategy is an indication of a low power mode; and
the WUS search space collision strategy comprises indicating to the base station that multicast data PDCCH is dropped due to insufficient processing capability in response to the scheduled M-WSS not being allocated processing capability in the PDCCH slot and a hybrid Automatic Repeat Request (ARQ) (HARQ) for a corresponding multicast session being activated.

10-14. (canceled)

15. A wireless device, comprising:
a processor configured with processor executable instructions to perform operations comprising:
determining whether a multicast search space (MSS) and a multicast wake-up search space (M-WSS) are scheduled by a base station to occur in a same slot; and
in response to determining that the MSS and the M-WSS are scheduled by the base station to occur in a same slot:
selecting for searching in the slot either the scheduled MSS or the scheduled M-WSS based on a priority assigned to MSS and M-WSS in a wake-up signal (WUS) search space collision strategy; and
monitoring a Physical Downlink Control Channel (PDCCH) for at least the selected one of either the scheduled MSSs or the scheduled M-WSS in the slot.

16. The wireless device of claim 15, wherein the processor is configured with processor-executable instructions to perform operations further comprising allocating any remaining processing capability in the PDCCH slot to monitoring the unselected one of the scheduled MSSs or the scheduled M-WSS.

17. The wireless device of claim 15, wherein the processor is configured with processor-executable instructions to perform operations such that the WUS search space collision strategy comprises prioritizing any scheduled MSS over the scheduled M-WSS in the slot.

18. The wireless device of claim 15, wherein the processor is configured with processor-executable instructions to perform operations further comprising:
receiving a search space configuration message from the base station, wherein the search space configuration message indicates the scheduled MSS, the scheduled M-WSS, and assigned search space identifiers (SS IDs) for the scheduled MSSs and the scheduled M-WSS, and
wherein the processor is configured with processor-executable instructions to perform operations such that the WUS search space collision strategy comprises prioritizing the scheduled MSS and the scheduled M-WSS in the slot based on their respective assigned SS IDs.

19. The wireless device of claim 15, wherein the processor is configured with processor-executable instructions to perform operations further comprising:
receiving the WUS search space collision strategy from the base station.

20. The wireless device of claim 19, wherein the processor is configured with processor-executable instructions to perform operations further comprising:
sending an indication of a power saving strategy for the wireless device to the base station, and
wherein the processor is configured with processor-executable instructions to perform operations such that receiving the WUS search space collision strategy from the base station comprises receiving the WUS search space collision strategy from the base station in response to sending the indication of the power saving strategy.

21. (canceled)

22. The wireless device of claim 20, wherein the processor is configured with processor-executable instructions to perform operations such that:
the indication of a power saving strategy is an indication of a high power mode; and
the WUS search space collision strategy comprises monitoring all on-durations in a current multicast-WUS (M-WUS) cycle in response to the scheduled M-WSS not being allocated processing capability in the PDCCH slot.

23. The wireless device of claim 20, wherein the processor is configured with processor-executable instructions to perform operations such that:
the indication of a power saving strategy is an indication of a low power mode; and
the WUS search space collision strategy comprises indicating to the base station that multicast data PDCCH is dropped due to insufficient processing capability in response to the scheduled M-WSS not being allocated processing capability in the PDCCH slot and a hybrid Automatic Repeat Request (ARQ) (HARQ) for a corresponding multicast session being activated.

24-28. (canceled)

29. A non-transitory processor readable medium having stored thereon processor-executable instructions configured to cause a processor of a wireless device to perform operations comprising:
determining whether a multicast search space (MSS) and a multicast wake-up search space (M-WSS) are scheduled by a base station to occur in a same slot; and
in response to determining that the MSS and the M-WSS are scheduled by the base station to occur in a same slot:
selecting for searching in the slot either the scheduled MSS or the scheduled M-WSS based on a priority assigned to MSS and M-WSS in a wake-up signal (WUS) search space collision strategy; and
monitoring a Physical Downlink Control Channel (PDCCH) for at least the selected one of either the scheduled MSSs or the scheduled M-WSS in the slot.

30. The non-transitory processor readable medium of claim 29, wherein the processor-executable instructions are configured to cause a processor of a wireless device to perform operations further comprising allocating any remaining processing capability in the PDCCH slot to monitoring the unselected one of the scheduled MSSs or the scheduled M-WSS.

31. The non-transitory processor readable medium of claim 29, wherein the processor-executable instructions are configured to cause a processor of a wireless device to perform operations such that the WUS search space collision strategy comprises prioritizing any scheduled MSS over the scheduled M-WSS in the slot.

32. The non-transitory processor readable medium of claim 29, wherein the processor-executable instructions are configured to cause a processor of a wireless device to perform operations further comprising:
receiving a search space configuration message from the base station, wherein the search space configuration message indicates the scheduled MSS, the scheduled M-WSS, and assigned search space identifiers (SS IDs) for the scheduled MSSs and the scheduled M-WSS, and
wherein the processor-executable instructions are configured to cause a processor of a wireless device to perform operations such that the WUS search space collision strategy comprises prioritizing the scheduled MSS and the scheduled M-WSS in the slot based on their respective assigned SS IDs.

33. The non-transitory processor readable medium of claim 29, wherein the processor-executable instructions are configured to cause a processor of a wireless device to perform operations further comprising:
receiving the WUS search space collision strategy from the base station.

34. The non-transitory processor readable medium of claim 33, wherein the processor-executable instructions are configured to cause a processor of a wireless device to perform operations further comprising:
sending an indication of a power saving strategy for the wireless device to the base station, and
wherein the processor-executable instructions are configured to cause a processor of a wireless device to perform operations such that receiving the WUS search space collision strategy from the base station comprises receiving the WUS search space collision strategy from the base station in response to sending the indication of the power saving strategy.

35. (canceled)

36. The non-transitory processor readable medium of claim 34, wherein the processor-executable instructions are configured to cause a processor of a wireless device to perform operations such that:
the indication of a power saving strategy is an indication of a high power mode; and
the WUS search space collision strategy comprises monitoring all on-durations in a current multicast-WUS (M-WUS) cycle in response to the scheduled M-WSS not being allocated processing capability in the PDCCH slot.

37. The non-transitory processor readable medium of claim 34, wherein the processor-executable instructions are configured to cause a processor of a wireless device to perform operations such that:
the indication of a power saving strategy is an indication of a low power mode; and
the WUS search space collision strategy comprises indicating to the base station that multicast data PDCCH is dropped due to insufficient processing capability in response to the scheduled M-WSS not being allocated processing capability in the PDCCH slot and a hybrid Automatic Repeat Request (ARQ) (HARQ) for a corresponding multicast session being activated.

38-42. (canceled)

43. A wireless device, comprising:
means for determining whether a multicast search space (MSS) and a multicast wake-up search space (M-WSS) are scheduled by a base station to occur in a same slot; and
in response to determining that the MSS and the M-WSS are scheduled by the base station to occur in a same slot:
means for selecting for searching in the slot either the scheduled MSS or the scheduled M-WSS based on a priority assigned to MSS and M-WSS in a wake-up signal (WUS) search space collision strategy; and
means for monitoring a Physical Downlink Control Channel (PDCCH) for at least the selected one of either the scheduled MSSs or the scheduled M-WSS in the slot.

44. The wireless device of claim 43, further comprising means for allocating any remaining processing capability in the PDCCH slot to monitoring the unselected one of the scheduled MSSs or the scheduled M-WSS.

45. The wireless device of claim 43, wherein the WUS search space collision strategy comprises prioritizing any scheduled MSS over the scheduled M-WSS in the slot.

46. The wireless device of claim 43, further comprising:
means for receiving a search space configuration message from the base station, wherein the search space configuration message indicates the scheduled MSS, the scheduled M-WSS, and assigned search space identifiers (SS IDs) for the scheduled MSSs and the scheduled M-WSS,
wherein the WUS search space collision strategy comprises prioritizing the scheduled MSS and the scheduled M-WSS in the slot based on their respective assigned SS IDs.

47. The wireless device of claim 43, further comprising:
means for receiving the WUS search space collision strategy from the base station.

48. The wireless device of claim 47, further comprising:
means for sending an indication of a power saving strategy for the wireless device to the base station, and
wherein means for receiving the WUS search space collision strategy from the base station comprises means for receiving the WUS search space collision strategy from the base station in response to sending the indication of the power saving strategy.

49. (canceled)

50. The wireless device of claim 48, wherein:
the indication of a power saving strategy is an indication of a high power mode; and
the WUS search space collision strategy comprises monitoring all on-durations in a current multicast-WUS (M-WUS) cycle in response to the scheduled M-WSS not being allocated processing capability in the PDCCH slot.

51. The wireless device of claim 48, wherein:
the indication of a power saving strategy is an indication of a low power mode; and
the WUS search space collision strategy comprises indicating to the base station that multicast data PDCCH is dropped due to insufficient processing capability in response to the scheduled M-WSS not being allocated processing capability in the PDCCH slot and a hybrid Automatic Repeat Request (ARQ) (HARQ) for a corresponding multicast session being activated.

52-56. (canceled)
